(19) United States
(12) Patent Application Publication
(10) Pub. No.: US 2002/0104431 A1
(43) Pub. Date: Aug. 8, 2002

(54) Method and apparatus for controlling the actuation of a hydraulic cylinder

(76) Inventors: Sohel Anwar, Canton, MI (US); Richard G. Ingram, Saint Charles, IL (US)

Correspondence Address: Byron G Buck II, Caterpillar Inc, Patent Department AB6490, 100 N E Adams Street, Peoria, IL, 61629-6490, US

(21) Appl. No.: 09/507,433

(22) Filed: Feb. 19, 2000

Related U.S. Application Data
(60) Provisional application No. 60/153,059, filed on Sep. 9, 1999.

(51) Int. Cl. F15B 13/044

(52) U.S. Cl. 91/459

(57) ABSTRACT

An apparatus and method of controllably moving a moveable element within a hydraulic motor is disclosed. A lever device produces an operator command signal indicative of a desired velocity of the moveable element. An electronic controller receives the operator command signal, compares the operator command signal to a limit value, and produces a limited command signal in response to the operator command signal being greater than the limit value. An electrohydraulic controller receives the operator command signal and responsively controls the movement of the moveable element.

This application claims the benefit of prior provisional patent application Ser. No. 60/153,059 filed Sep. 9, 1999.

### TECHNICAL FIELD

This invention relates generally to an apparatus for controlling the actuation of a hydraulic cylinder and, more particularly, to an apparatus for controlling the velocity of the hydraulic cylinder piston.

### BACKGROUND ART

Hydraulic systems are particularly useful in applications requiring significant power transfer and are extremely reliable in harsh environments, for example, in construction and industrial work places. Earthmoving machines, such as excavators, backhoe loaders, and wheel type loaders are a few examples where the large power output and reliability of hydraulic systems are desirable.

Typically, a diesel or internal combustion engine powers the hydraulic system. The hydraulic system, in turn, provides power to the machine's work implement. The hydraulic system typically includes a pump for supplying pressurized hydraulic fluid and a directional valve for controlling the flow of hydraulic fluid to a hydraulic motor which in turn delivers power to a work attachment, e.g., a bucket.

A shortcoming of conventional systems is that an operator must be highly skilled in order to accurately and efficiently perform the various work functions using the earthmoving machine. The size, power and expense of typical work machines requires a highly skilled operator to avoid potential damage to the machine. An operator also must develop high level skills at manipulating the plurality of levers in specific sequences and with specific timing in order to efficiently perform various work functions. Another shortcoming of conventional systems is improving the transient response of the hydraulic system to reduce the amount of jerk, i.e., quick abrupt motion of the work implement. Jerk may cause operator fatigue which may reduce productivity.

The present invention is directed toward overcoming one or more of the problems as set forth above.

### DISCLOSURE OF THE INVENTION

In one aspect of the present invention, an apparatus controllably moves a moveable element within a hydraulic motor. A lever device produces an operator command signal indicative of a desired velocity of the moveable element. An electronic controller receives the operator command signal, compares the operator command signal to a limit value, and produces a limited command signal in response to the operator command signal being greater than the limit value. An electrohydraulic controller receives the operator command signal and responsively controls the movement of the moveable element.

In another aspect of the present invention a method of controllably moving a moveable element within a hydraulic motor is provided. An operator command signal indicative of a desired velocity of the moveable element is established. The operator command signal is received, compared to a limit value, and produces a flow control signal in response to the operator command signal being greater than the limit value. The movement of the moveable element is controlled in response to the flow control signal.

### BRIEF DESCRIPTION OF THE DRAWINGS

For a better understanding of the present invention, reference may be made to the accompanying drawings in which:

FIG. 1 illustrates an electrohydraulic system for controlling the actuation of a hydraulic cylinder;

FIG. 2 illustrates a control process for controlling the actuation of the hydraulic cylinder; and

FIG. 3 illustrates a graph of a limited command signal and operator command signal.

### BEST MODE FOR CARRYING OUT THE INVENTION

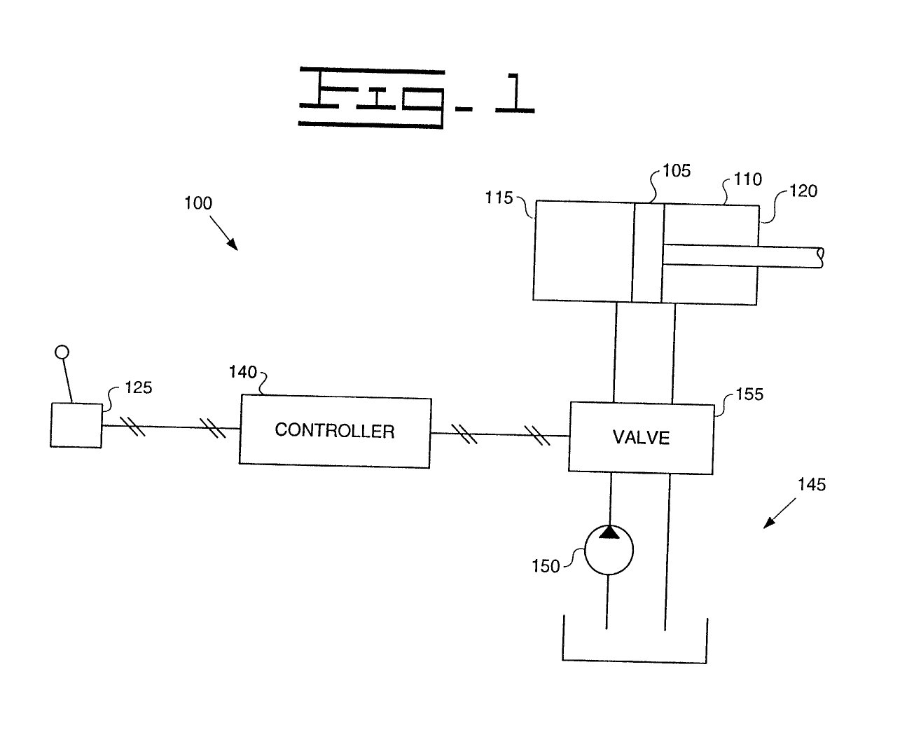

With reference to FIG. 1, an apparatus 100 is adapted to control a moveable element 105 within a hydraulic motor 110. In the preferred embodiment, the hydraulic motor 110 is a hydraulic cylinder having a first end 115 and a second end 120, and the moveable element 105 is a piston within the cylinder, as shown.

A lever device 125 establishes an operator command signal indicative of a desired velocity and direction of movement of the piston 105. The electronic controller 140 receives the operator command signal and produces a flow control signal.

An electrohydraulic controller 145 receives the flow control signal and controls the movement of the piston 105 in accordance with the flow control signal. The electrohydraulic controller 145 includes a source of pressurized fluid represented by a pump 150 and a control valve 155 connected between the pump 150 and the cylinder 110. The control valve 155 regulates or controls the flow of pressurized fluid to the first and second end 115, 120 of the cylinder 110 in response to the flow control signal. In one embodiment, the control valve 155 may include electrically actuatable solenoids that receive the flow control signal and controllably position the spool of the valve 155 to create the desired flow to the cylinder 110. In another embodiment, the control valve 155 may include a main valve adapted to direct pressurized fluid to the cylinder 110 and a pilot valve adapted to direct pilot fluid to the main valve to control the movement of the main valve spool. In this embodiment, the pilot valve would include solenoids that receive the flow control signal.

Preferably, the electronic controller 140 is embodied in a microprocessor based system which utilizes arithmetic units to control process according to software programs. Typically, the programs are stored in read-only memory, random-access memory or the like. The electronic controller 140 may include one or more control modules to control the movement of the piston 105 in accordance with the flow control signal. It is noted that the term microprocessor is meant to at least include microcomputers, microprocessors, integrated circuits, and the like capable of being programmed. The electronic controller 140 preferably contains sufficient electronic circuitry to convert input signals from a plurality of sensors, make several computations based on the input signals, and generate output signals with sufficient power to drive the plurality of devices. Preferably, the microprocessor is programmed with the plurality of pre-selected logic rules for producing one or more output signals in response to receiving one or more input signals.

The present invention is used to limit the operator velocity command to reduce the jerk associated with quick transient operator velocity command responses. Thus, the associated hydraulic system transient response will be made smooth; providing for reduced operator fatigue and increased productivity.

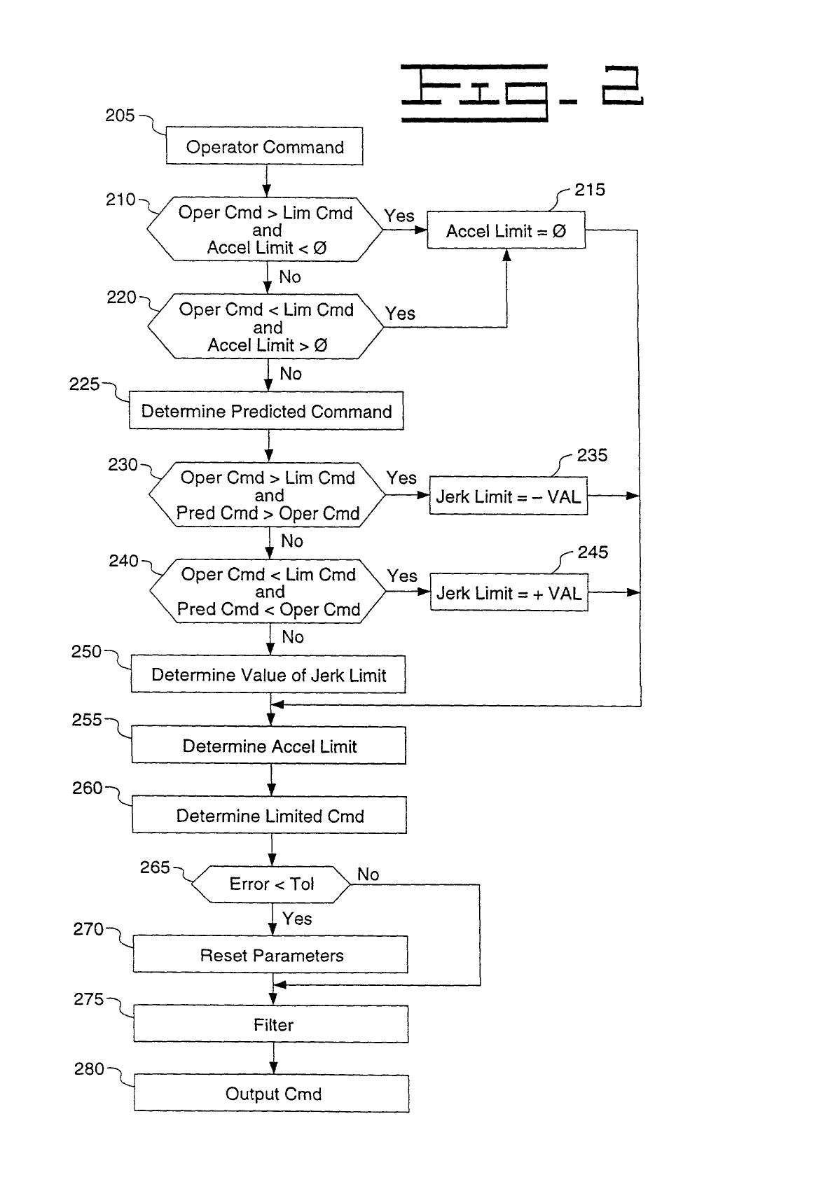

Referring now to FIG. 2, a preferred embodiment of the present invention 200 is shown in relation to a flow chart representing a software program. Referring to block 205, an operator command signal is produced which represents a desired velocity of the work implement. At decision block 210, the magnitude of the operator command signal is compared to a limited command signal, and the magnitude of an acceleration limit value is compared to zero. The limited command signal represents an ideal velocity command that produces very little jerk. Or, in other words, the limited command signal provides for a smooth control of the hydraulic cylinder velocity. The acceleration limit value represents a desired slope of the limited command signal. Initially, the limited command signal is set to the value of the operator command signal and the acceleration limit value is set to zero.

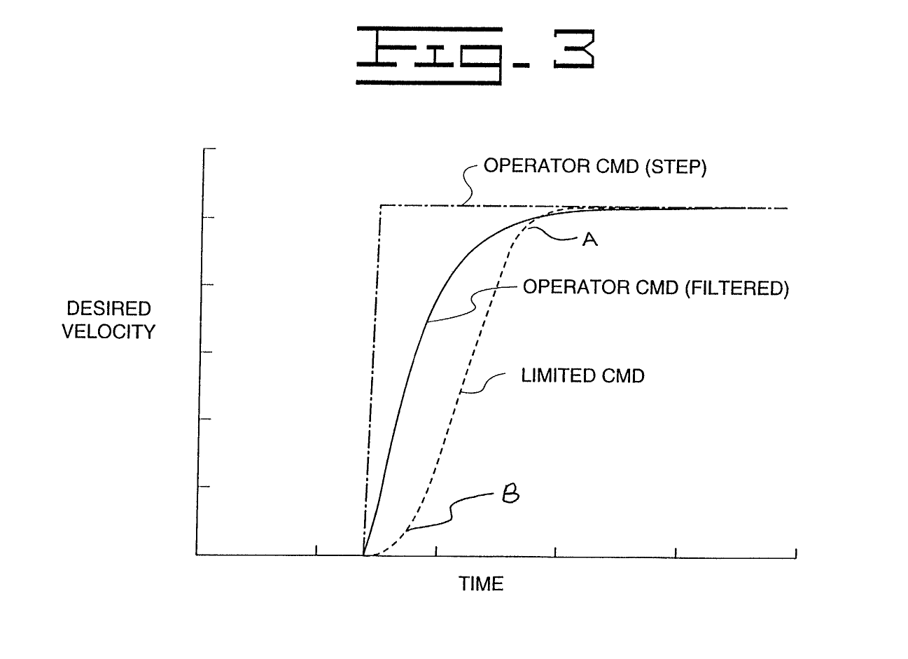

The process proceeds to block 215 where the acceleration limit value is set equal to zero when the operator command signal is found to be greater than the limited command signal and the acceleration limit is found to be less than zero. Otherwise, the process continues to decision block 220. When the value of the operator command signal is less than the value of the limited command signal and the acceleration limit is greater than zero, the process reverts back to block 215. Otherwise, the process continues to block 225 where a predicted command value is determined. The predicted command value represents where an inflection point of the limited command signal occurs. For example, an inflection point occurs when the slope of the limited command signal makes a directional change. Reference is now made to FIG. 3, where the operator command signal is illustrated as a step value and as a filtered value. The third curve represents the limited command signal. Point A and Point B represent inflection points of the limited command signal. The predicted command value is determined in accordance with the following equation:

Predicted Command=Limited CommandVal_ue+sign(accel limit)*[abs(accel limit)*dt* (abs(accel limit)*dt+jerk limit*dt*dt)]/(2* jerk limit*dt*dt)

Once the predicted command value is determined, the process proceeds to block 230 where the value of the operator command signal is compared to the value of the limited command signal and the predicted command value is compared to the value of the operator command signal. Where the operator command value is greater than the limited command value and the predicted command value is greater than the limited command value, then the process continues to block 235 where a jerk limit is set. Decision block 230 determines the point of inflection of the limited command signal and if the represented condition exists, then the limited command signal is said to be at an inflection point (point B). Consequently, a jerk limit value is set to the negative of parameter VAL. Otherwise, the process continues to block 240. If the value operator command signal is less than the value limited command signal and the predicted command value is less than the operator command value, then the limited command signal is said to be at an inflection point (point A); consequently, the jerk limit is set to the positive of parameter VAL as shown in block 245. VAL is an operator tuned parameter based on a desired response time of the system. VAL provides for a smooth operation of the hydraulic cylinder. Otherwise, the limited command signal is not considered to be at an inflection point and the process continues to block 250 where the sign of the jerk limit is determined in accordance with the following equation:

Jerk Limit.=sign(OPER Cmd−LIM Cmd)*VAL

The process proceeds to block 255 where the acceleration limit is determined. The acceleration is determined by integrating the value of the jerk limit. Once the acceleration limit is determined, the process proceeds to block 260 where the value of the limited command is determined. The limited command value is determined by integrating the acceleration limit. Such integration steps are calculated in accordance with well-known numerical integration techniques. The process now proceeds to decision block 265 where the error is compared to a tolerance value TOL. The system error is said to be the absolute value of the magnitude of the operator command signal subtracted from the magnitude of the limited command signal. The tolerance value or TOL is predetermined value. If the error is less than the tolerance value, then the process proceeds to block 270 where the various parameters are reset. This includes the value of the limited command signal being set equal to the value of operator command signal and the acceleration limit and jerk limit values being set equal to zero. In other words, where the operator command signal is substantially the same as the limited command signal, then the parameters are reset. The process proceeds to block 275 where the value of the limited command signal is filtered with a low pass filter to remove any spurious wave forms and is output or produced as the flow control signal shown by block 280.

Industrial Applicability

The present invention is directed toward producing a flow control signal that provides for a smooth transient response of the hydraulic system to avoid the negative effects associated with jerkiness, i.e., quick abrupt motion of the work implement. The present invention accomplishes this by limiting the flow control signal to the lesser of the operator command signal magnitude and the limit value. Advantageously, the limit value can vary based on operator input. For example, the limit value can be selectable by the operator from one of a plurality of values. Thus, the limit value can be tuned by the operator to achieve the desired response of the system.

Other aspects, objects and advantages of the present invention can be obtained from a study of the drawings, the disclosure and the appended claims.

1. An apparatus for controllably moving a moveable element within a hydraulic motor, comprising:
a lever device for establishing an operator command signal indicative of a desired velocity of the moveable element;
an electronic controller adapted to receive the operator command signal, compare the operator command signal to a limit value, and produce a flow control signal in response to the operator command signal being greater than the limit value; and
an electrohydraulic controller adapted to receive the flow control signal and responsively control the movement of the moveable element.

2. An apparatus, as set forth in claim 1, wherein the hydraulic motor is a hydraulic cylinder having a first end and a second end, and the moveable element is a piston.

3. An apparatus, as set forth in claim 2, wherein the limit value is selectable by the operator.

4. An apparatus, as set forth in claim 3, wherein the electrohydraulic controller includes a source of pressurized fluid and a control valve being connected between the source of pressurized fluid and the hydraulic cylinder and being adapted to control the flow of pressurized fluid to the hydraulic cylinder in response to the flow control signal.

5. A method of controllably moving a moveable element within a hydraulic motor, comprising:
establishing an operator command signal indicative of a desired velocity of the moveable element;
receiving the operator command signal, comparing the operator command signal to a limit value, and producing a flow control signal in response to the operator command signal being greater than the limit value; and
controlling the movement of the moveable element in response to the flow control signal.

6. The method of claim 5, including the step of an operator selecting the limit value.

7. The method of claim 6, including the step of controlling the flow of pressurized fluid to the hydraulic cylinder in response to the flow control signal.
